(19) United States
(12) Patent Application Publication
(10) Pub. No.: US 2026/0218834 A1
(43) Pub. Date: Jul. 30, 2026

(54) FLUID DISCHARGE END CAP WITH EXTERNAL GRAVITY-ACTUATED CLOSURE MEMBER

(71) Applicant: Mark Austen, Parrish, FL (US)

(72) Inventor: Mark Austen, PARRISH, FL (US)

(21) Appl. No.: 19/574,346

(22) Filed: Mar. 22, 2026

(51) Int. Cl. F16L 55/115

(52) U.S. Cl. CPC F16L 55/115

(57) ABSTRACT

A fluid discharge control assembly includes a cap member attachable to a conduit and a closure member positioned external to the conduit and outside an internal flow path. The closure member opens in response to fluid discharge and closes under gravity to restrict reverse flow and external intrusion.

### CROSS-REFERENCE TO RELATED APPLICATIONS

None.

### FEDERALLY SPONSORED RESEARCH AND DEVELOPMENT

Not Applicable

### FIELD OF THE INVENTION

The present invention relates to fluid discharge systems, and more particularly to devices positioned at the outlet of a conduit for controlling fluid discharge and restricting reverse flow and external intrusion.

### BACKGROUND OF THE INVENTION

Fluid conduits, including condensate drain lines used in HVAC systems, commonly terminate in open outlet ends. These open outlets allow undesirable conditions such as:
(a) Reverse airflow or fluid backflow
(b) Entry of insects, pests, and debris
(c) Odor infiltration

Existing solutions often incorporate internal valve assemblies positioned within the conduit or complex valve bodies requiring installation within the flow path. These configurations increase complexity, cost, and susceptibility to clogging or failure. Additionally, many existing valves rely on springs or flexible materials that degrade over time. Accordingly, there is a need for a simple, externally mounted discharge control device that operates reliably without internal valve structures or spring-assisted mechanisms.

### SUMMARY OF THE INVENTION

The present invention provides a fluid discharge control assembly including a cap member attachable to an outlet of a conduit and a closure member positioned external to the conduit.

The closure member is configured to:
(a) Open in response to fluid exiting the conduit
(b) Return to a closed position under gravitational force

In the closed position, the closure member covers the outlet and restricts reverse flow and external intrusion. The invention eliminates the need for internal valve bodies and spring-based actuation, providing a simple, durable, and retrofit-friendly solution. The closure member remains external to the conduit and does not extend into an internal flow path of the conduit.

### BRIEF DESCRIPTION OF THE DRAWINGS

FIG. 1 is a side view of the assembly showing the closure member in an open position.

FIG. 2 is a front view showing the closure member aligned with the outlet.

FIG. 3 is a cross-sectional side view showing the closure member in a closed position engaging a seating surface (8).

### DETAILED DESCRIPTION OF THE INVENTION

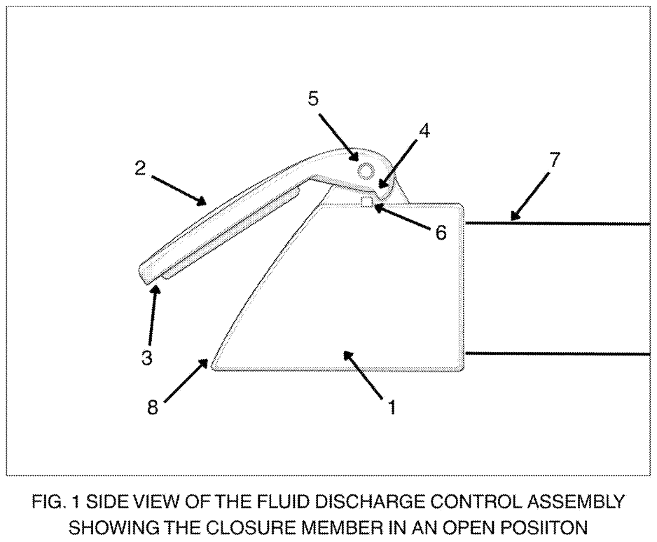

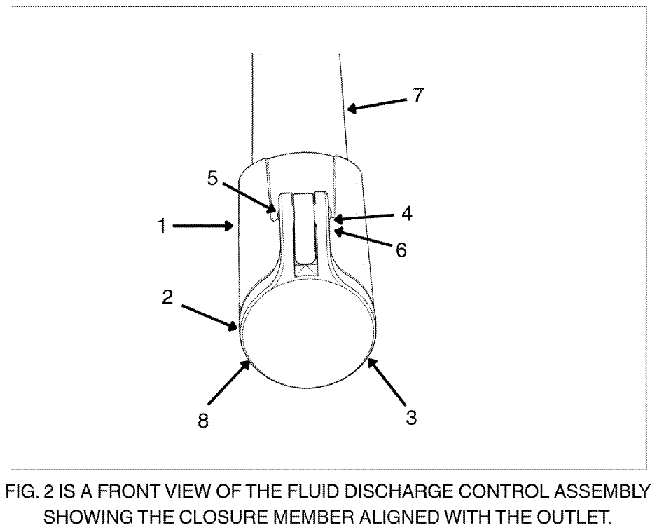

Referring to FIGS. 1-3, a fluid discharge control assembly (100) includes a conduit (7) having an outlet end and a cap member (1) coupled to the outlet end.

The cap member (1) is positioned externally of the conduit and is configured to cover or partially enclose the outlet end.

A closure member (2) is mounted to the cap member (1) and is positioned outside the conduit.

The closure member (2) includes a body portion (3) sized to substantially cover the outlet end of the conduit.

Importantly, the closure member (2) remains external to the conduit in both open and closed positions and is not positioned within an internal valve body.

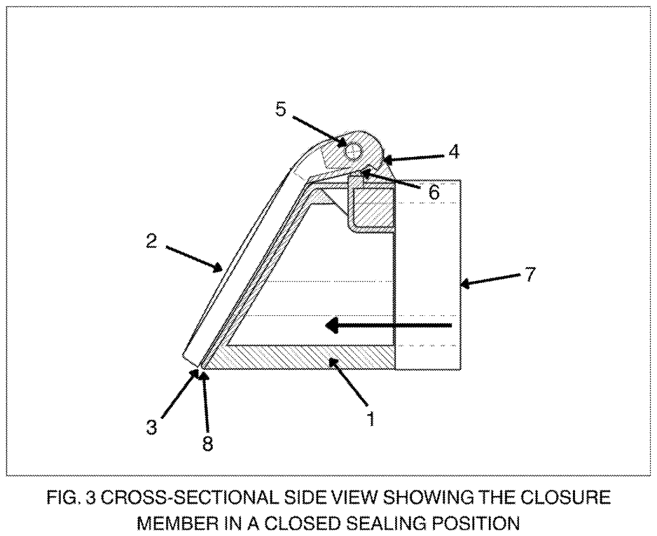

The closure member (2) is movable between:
(a) An open position (FIG. 1), in which fluid is permitted to discharge from the conduit
(b) A closed position (FIG. 3), in which the closure member (2) covers the outlet end

During operation:
1. Fluid exiting the conduit causes the closure member (2) to move to the open position
2. When fluid flow decreases or stops, the closure member returns to the closed position under the force of gravity
In the closed position, the closure member (2) engages a seating surface (8) formed on the cap member (1) and positioned external to the conduit to provide a sealing interface. The closure member (2) includes a sealing edge or contact portion (3) configured to contact the seating surface (8), thereby restricting reverse flow, air infiltration, and entry of insects and debris.

The closure member (2) is configured to minimize sticking due to moisture or debris accumulation, thereby improving reliability during repeated operation. In one embodiment, the closure member (2) is pivotally supported by the cap member (1) via a hinge structure including:
(a) a hinge arm (4)
(b) A pivot pin (5)
(c) a hinge support structure (6)

However, the closure member may be mounted using other movement mechanisms, provided that the closure member remains externally positioned and gravity-actuated.

The closure member (2) may be:
(a) Circular
(b) Oval
(c) Or any shape suitable to cover the outlet end

In a preferred embodiment:
(a) The cap member (1) and closure member (2) are formed of a rigid polymer, such as polyvinyl chloride (PVC)

Other materials may be used, including:
(a) Semi-rigid polymers
(b) Composite materials

The cap member (1) may be attached to the conduit (7) using:
(a) Solvent welding
(b) Press-fit engagement
(c) Threaded connection

The cap member may be removable or permanently attached.

### DETAILED DESCRIPTION OF AN ALTERNATIVE EMBODIMENT

The invention is not limited to the specific embodiment shown.

Variations include:
(a) Different mounting configurations for the closure member
(b) Alternative pivoting or movement mechanisms
(c) Different shapes and sizes of closure members
(d) Use in various fluid systems, including condensate drains, plumbing systems, and other discharge conduits

In all embodiments, the closure member remains positioned externally of the conduit and operates without spring-assisted actuation.

1. A fluid discharge control assembly comprising:
a conduit having an outlet end;
a cap member coupled to the outlet end; and
a closure member movably supported by the cap member and positioned entirely external to the conduit and outside an internal flow path of the conduit;
wherein the closure member is movable relative to the cap member between:
(i) an open position permitting fluid discharge from the conduit; and
(ii) a closed position covering the outlet end;
wherein the closure member is configured to move to the open position in response to fluid exiting the conduit and to return to the closed position under gravitational force; and
wherein the closure member includes a sealing edge configured to engage a seating surface formed on the cap member in the closed position to restrict reverse flow and external intrusion.

2. The assembly of claim 1, wherein the cap member is configured as an end cap that covers the outlet end of the conduit.

3. The assembly of claim 1, wherein the closure member remains entirely external to the conduit in both the open position and the closed position.

4. The assembly of claim 1, wherein the closure member is positioned entirely outside an internal valve body.

5. The assembly of claim 1, wherein the closure member is pivotally supported by the cap member.

6. The assembly of claim 5, wherein the closure member is supported by a hinge structure including a pivot pin.

7. The assembly of claim 6, wherein the hinge structure includes interlocking hinge portions formed on the cap member and the closure member.

8. The assembly of claim 1, wherein the closure member is sized to substantially cover the outlet end.

9. The assembly of claim 1, wherein the closure member is generally circular or oval.

10. The assembly of claim 1, wherein the cap member and closure member are formed of a rigid polymer.

11. The assembly of claim 10, wherein the rigid polymer comprises polyvinyl chloride (PVC).

12. The assembly of claim 1, wherein the cap member is configured for attachment to the conduit by at least one of solvent welding, press-fit engagement, or threaded connection.

13. The assembly of claim 1, wherein the closure member is configured to restrict reverse airflow through the conduit.

14. The assembly of claim 1, wherein the closure member is configured to prevent entry of insects.

15. The assembly of claim 1, wherein the closure member is configured to prevent entry of debris.

16. The assembly of claim 1, wherein the seating surface is formed on an exterior portion of the cap member.

17. The assembly of claim 1, wherein the closure member contacts the seating surface along a lower edge portion in the closed position.

18. The assembly of claim 1, wherein the closure member is spaced from the outlet end to reduce accumulation of debris.

19. The assembly of claim 1, wherein the closure member is configured to minimize adhesion due to moisture.

20. A condensate drain assembly comprising:
a drain conduit having an outlet end; an end cap attached to the outlet end; and a closure member configured as a flapper and pivotally mounted to the end cap, wherein the closure member is positioned entirely external to the conduit and is configured to open in response to condensate discharge and close under gravity to cover the outlet end.

21. A method of controlling discharge from a conduit comprising:
attaching a cap member externally to an outlet of the conduit;
allowing fluid to exit the conduit and move a closure member to an open position; and
allowing the closure member to return to a closed position solely under gravity to cover the outlet.

22. The assembly of claim 1, wherein the closure member operates without a spring biasing mechanism.

23. The assembly of claim 1, wherein the closure member opens solely in response to fluid flow and closes solely under gravitational force.

24. The assembly of claim 1, wherein the closure member is movable relative to the cap member by at least one of pivoting, flexing, or translating movement.

25. The assembly of claim 1, wherein the closure member is spaced from the outlet end such that the closure member does not contact fluid within the conduit during normal discharge.

26. The assembly of claim 1, wherein the closure member permits fluid discharge in a first direction and restricts flow in an opposite direction.

27. The assembly of claim 1, wherein the closure member does not extend into the conduit and does not obstruct the internal flow path of the conduit in either the open position or the closed position.

28. The assembly of claim 1, wherein the cap member is configured to be installed onto an existing conduit without modification of the conduit.

29. The assembly of claim 1, wherein the closure member is configured to open in response to low-pressure fluid discharge without the use of a biasing element.

30. The assembly of claim 1, wherein gravitational force is the sole force returning the closure member to the closed position.

31. The assembly of claim 1, wherein the closure member is fully exposed to an external environment outside of the conduit.

32. The assembly of claim 1, wherein the closure member operates passively without electrical, magnetic, or mechanical actuation other than fluid flow and gravity.

33. The assembly of claim 1, wherein the cap member comprises a unitary structure forming both an outlet cover and a support for the closure member.

34. The assembly of claim 1, wherein the closure member forms a seal without requiring deformation of the closure member.

35. The assembly of claim 1, wherein the closure member is positioned downstream of and spaced apart from the outlet end of the conduit such that the closure member remains external to fluid exiting the conduit.

36. The assembly of claim 1, wherein the closure member remains completely outside a fluid flow path defined within the conduit.
